(19) United States
(12) Patent Application Publication
(10) Pub. No.: US 2026/0046409 A1
(43) Pub. Date: Feb. 12, 2026

(54) ADAPTIVE SPATIAL SCANNING FOR NON-SEPARABLE TRANSFORMS

(71) Applicant: Tencent America LLC, Palo Alto, CA (US)

(72) Inventors: Yifan WANG, Palo Alto, CA (US); Yonguk YOON, Palo Alto, CA (US); Lien-Fei CHEN, Palo Alto, CA (US); Biao WANG, Palo Alto, CA (US); Roman CHERNYAK, Palo Alto, CA (US); Ziyue XIANG, Palo Alto, CA (US); Shan LIU, Palo Alto, CA (US)

(21) Appl. No.: 19/294,171

(22) Filed: Aug. 7, 2025

Related U.S. Application Data
(60) Provisional application No. 63/682,240, filed on Aug. 12, 2024.
(60) Provisional application No. 63/712,390, filed on Oct. 25, 2024.
(60) Provisional application No. 63/720,085, filed on Nov. 13, 2024.
(60) Provisional application No. 63/738,614, filed on Dec. 24, 2024.

(51) Int. Cl. H04N 19/129; H04N 19/159; H04N 19/176; H04N 19/196

(52) U.S. Cl. CPC H04N 19/129; H04N 19/159; H04N 19/176; H04N 19/196

(57) ABSTRACT

An example method of video decoding includes receiving a video bitstream comprising a plurality of blocks, including a current block, and determining a direction associated with the current block. The method also includes selecting a spatial scanning order for the current block based on the direction, and reconstructing the current block using the spatial scanning order. Instructions for performing the example method may be stored in a computer system or storage medium.

### RELATED APPLICATIONS

This application claims priority to:
U.S. Provisional Patent Application No. 63/682,240 entitled “Adaptive Spatial Scanning for Non-Separable Transforms,” filed Aug. 12, 2024,
U.S. Provisional Patent Application No. 63/712,390 entitled “Advanced Classifier for Custom Transform Kernels,” filed Oct. 25, 2024,
U.S. Provisional Patent Application No. 63/720,085 entitled “Inter LFNST/NSPT Re-Classification,” filed Nov. 13, 2024, and
U.S. Provisional Patent Application No. 63/738,614 entitled “Non-Primary Transform Kernel Set Selection,” filed Dec. 24, 2024,
each of which is hereby incorporated by reference in its entirety.

### TECHNICAL FIELD

The disclosed embodiments relate generally to video coding, including but not limited to systems and methods for determining spatial scanning orders and performing data transforms.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

The present disclosure describes a set of methods for video (image) compression, including methods of applying adaptive spatial scanning for transforms. Adaptive scanning can maximize similarities, which improves the energy compaction of the transform thereby improving coding efficiency. The present disclosure further describes applying a classifier to determine which transform to apply. For example, a classifier may be employed to determine which transform set and/or transform kernel to use for a current block. Using the classifier to select the most appropriate transform can improve coding efficiency, e.g., by performing a more accurate transformation to the video data.

In accordance with some embodiments, a method of video decoding includes (i) receiving a video bitstream (e.g., a coded video sequence) comprising a plurality of blocks, including a current block; (ii) determining a direction associated with the current block; (iii) selecting a spatial scanning order for the current block based on the direction; and (iv) reconstructing the current block using the spatial scanning order.

In accordance with some embodiments, a method of video encoding includes (i) receiving video data (e.g., a source video sequence) comprising a plurality of blocks, including a current block; (ii) determining a direction associated with the current block; (iii) selecting a spatial scanning order for the current block based on the direction; and (iv) encoding the current block using the spatial scanning order.

In accordance with some embodiments, a method of video decoding includes (i) receiving a video bitstream (e.g., a coded video sequence) comprising a plurality of blocks, including a current block; (ii) determining a direction of the current block; (iii) selecting a transform set for the current block based on the direction; and (iv) reconstructing the current block using the transform set.

In accordance with some embodiments, a method of video decoding includes (i) receiving a video bitstream (e.g., a coded video sequence) comprising a plurality of blocks, including a current block; (ii) determining a transform kernel set for the current block using a classifier selected from a set of two or more classifiers; and (iii) reconstructing the current block using a transform kernel from the transform kernel set.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A-4C illustrate example prediction blocks, residual blocks, and reconstructed blocks according to some embodiments.

FIGS. 5A-5D illustrate example scanning orders in accordance with some embodiments.

FIGS. 6A-6B illustrate example decision trees for classifiers in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including transform coding. The disclosed techniques include techniques for determining scanning orders for transform coding and using classifiers for selecting transform coding parameters (e.g., transform sets and kernels). For example, a spatial scanning order may be selected for a current block based on a direction associated with the current block (e.g., a direction corresponding to a prediction mode for the current block). In this way, an adaptive scanning order may be applied. Adaptive scanning can maximize similarities, which improves the energy compaction of the transform, thereby improving the coding efficiency. As another example, a transform set/kernel may be selected for the current block based on the direction associated with the current block. The transform set/kernel may be selected using a classifier (e.g., by providing the direction associated with the current block to the classifier). Using the classifier to select the most appropriate transform may improve coding efficiency as compared to predefined transform selections (e.g., by providing more accurate transform parameters).

### Example Systems and Devices

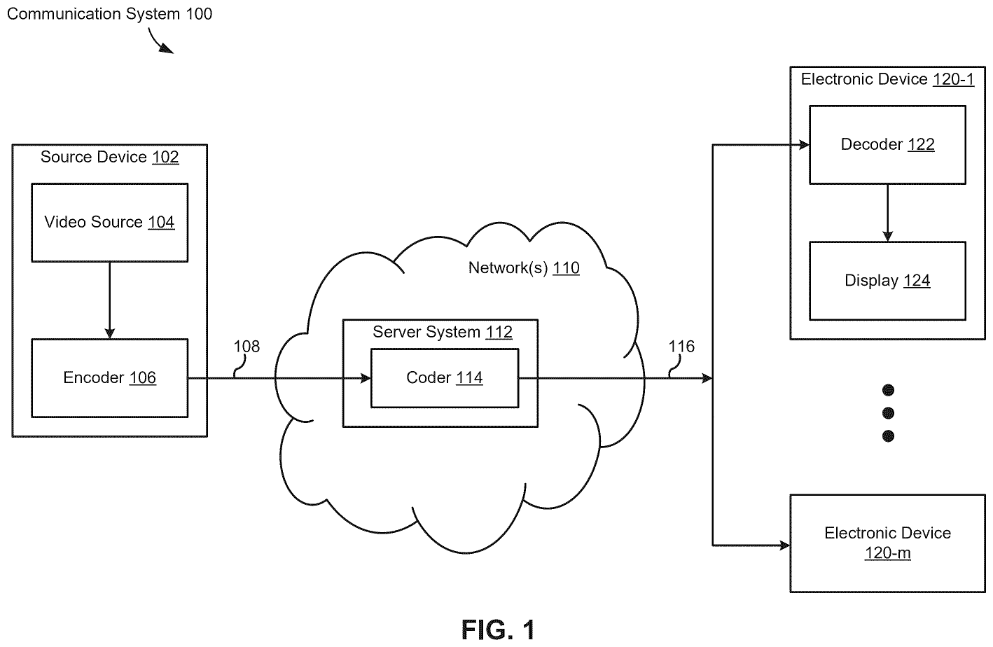

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including, e.g., wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116. In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

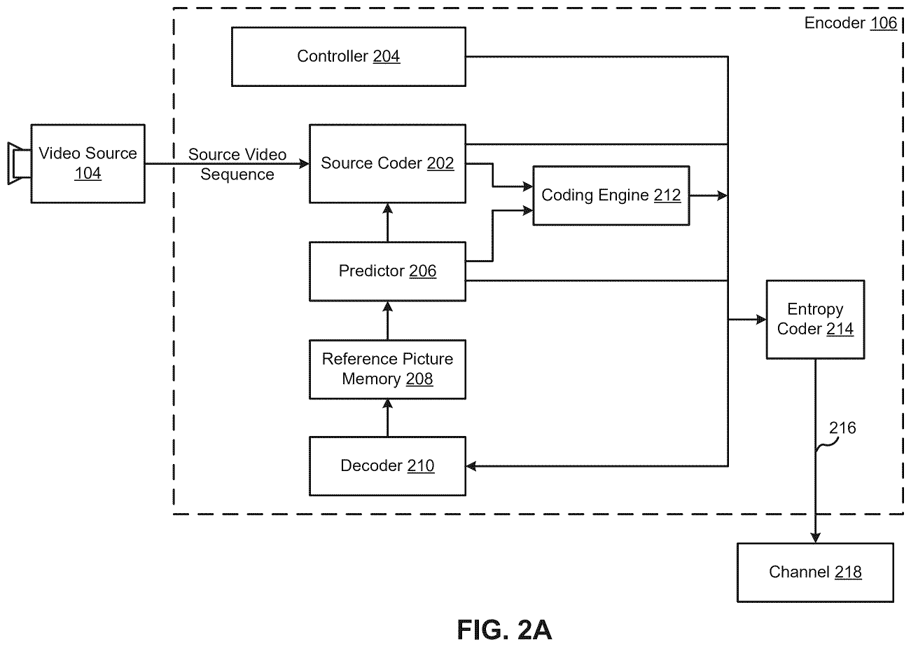

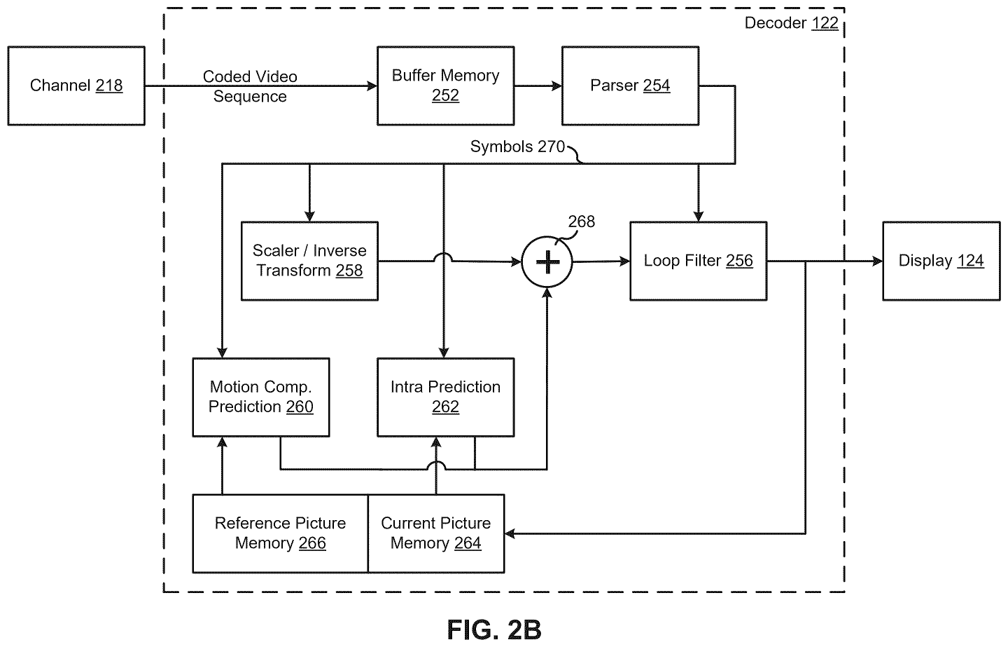

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (e.g., by parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. Levels may restrict the maximum picture size, maximum frame rate, maximum reconstruction sample rate (measured in, e.g., megasamples per second), maximum reference picture size, and so on. Limits set by levels may be further restricted through Hypothetical Reference Decoder (HRD) specifications and metadata for HRD buffer management signaled in the coded video sequence.

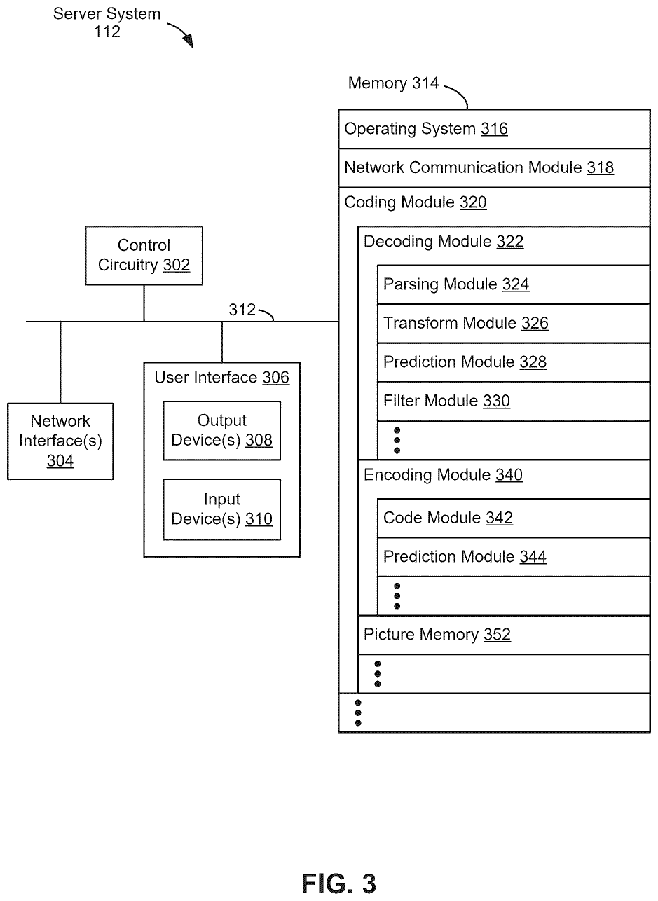

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As mentioned previously, the present disclosure describes transform coding tools that employ adaptive spatial scanning and categorization.

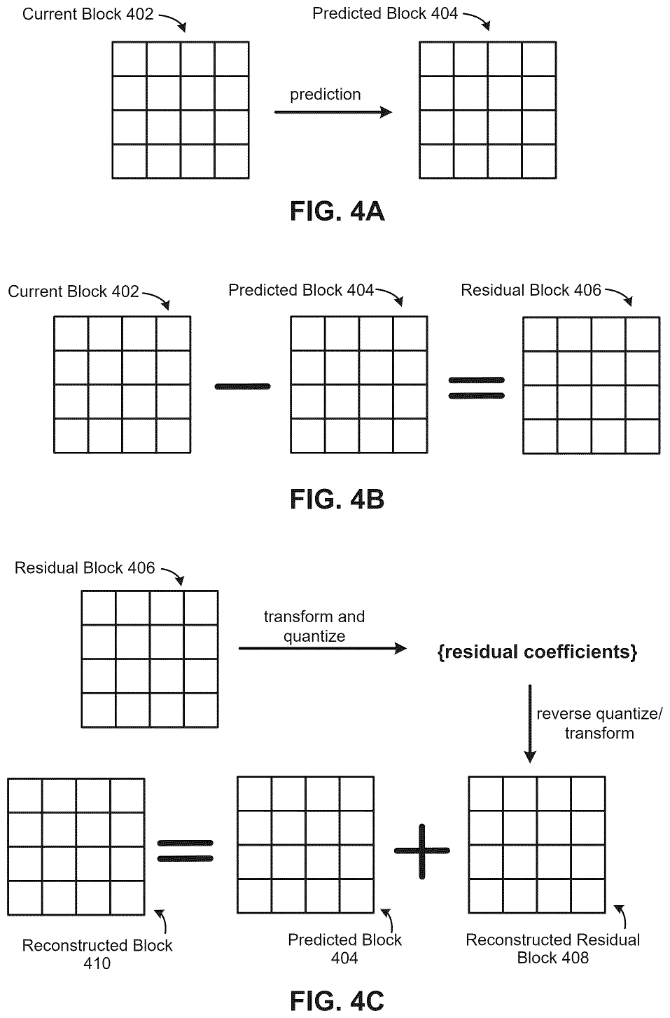

Turning briefly to example coding using prediction and residual blocks, FIG. 4A illustrates the computation of a prediction block in accordance with some embodiments. In the example of FIG. 4A, an intra prediction is performed on a current block 402 to generate a predicted block 404. In some embodiments, an inter prediction is performed to generate the predicted block. The current block 402 includes a set of samples (e.g., pixel blocks) and the prediction block 404 includes a set of predictions that correspond to the set of samples. FIG. 4B illustrates the computation of a residual block in accordance with some embodiments. As shown in FIG. 4B, the prediction block 404 is subtracted from the current block 402 to generate a residual block 406 that includes a set of residues. For example, respective differences are calculated between each sample and the corresponding prediction. FIG. 4C illustrates the computation of a reconstructed block in accordance with some embodiments. As shown in FIG. 4C, the residual block 406 undergoes one or more transformations and quantization to generate a set of residual coefficients. The set of residual coefficients may be transmitted from an encoder component to a decoder component as part of a video bitstream. The set of residual coefficients undergo a reverse quantization and reverse transformation to generate a reconstructed residual block 408. The reconstructed residual block 408 is combined with the predicted block 404 (e.g., reconstructed residues of the reconstructed residual block 408 are added to predictions of the prediction block 404) to generate a reconstructed block 410 corresponding to the current block 402.

In some existing video and image codecs, there are techniques to select custom (e.g., non-separable) transform kernels depending on available information such as intra prediction mode. Additionally, similar techniques can be applied for inter-coded blocks where the block predictor can be used to select the class based on its characteristics, such as dominant direction, mimicking an intra prediction mode for an intra-coded block.

Some image and video coding standards follow a hybrid framework. A hybrid video coding framework may include the following modules: intra prediction, inter prediction, transform, quantization and in-loop filter. In video codecs such as ECM, transform has been used to de-correlate the residuals for efficient coding. Apart from DCT, non-separable transforms such as a low-frequency non-separable transform (LFNST) and a non-separable primary transform (NSPT) may be used to perform non-separable transform, which can provide better energy compactions. In LFNST/NSPT, the spatial residual block may use raster scanning to convert the 2D block into 1D array. As described below, the intra prediction mode of a current block may be used to infer the transform set that will be applied on current block (e.g., resulting in 35 transform sets).

Adaptive spatial scanning may be applied to non-separable transforms to adaptively convert a 2D block into a 1D array. A small number of transform sets (e.g., less than 35) may be trained based on all the 1D arrays from different (scanning) modes. In this way, the model size may be reduced and the generalizability of the transform kernels may be increased.

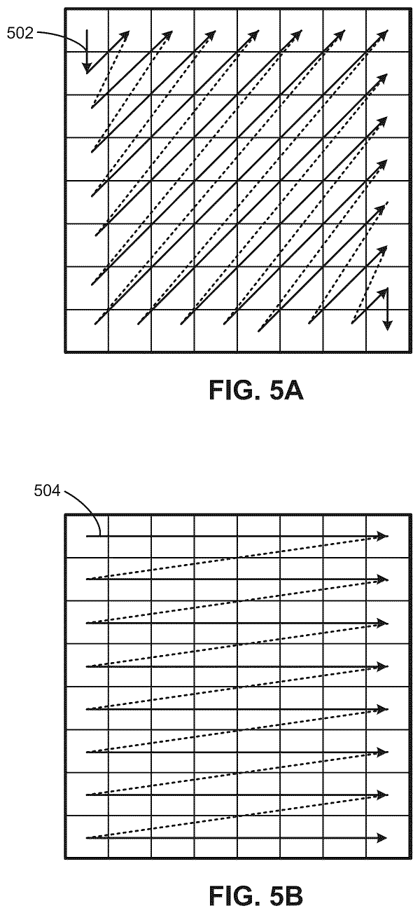

FIGS. 5A-5D illustrate example scanning orders in accordance with some embodiments. FIG. 5A shows an example diagonal scan 502 for an 8×8 block indicated by the arrowed lines. The solid lines indicate scanning orders whereas the dashed lines indicate transitions. As an example, the diagonal scan may be used for intra mode 2. FIG. 5B shows an example horizontal scan 504 for an 8×8 block. As an example, the diagonal scan may be used for intra mode 18. FIG. 5C shows an example vertical scan 506 for an 8×8 block. As an example, the diagonal scan may be used for intra mode 50. FIG. 5D shows an example scanning order that is based on a directionality of the coefficients of the 8×8 block.

Several techniques are disclosed for classifying intra- and inter-coded blocks. Without loss of generality, any transform kernels classification methods can be applied to custom transform kernels (e.g., non-conventional transform kernels such as DCT and DST), including but not limited to, primary and secondary non-separable transforms. As used herein, the term “transform set” may refer to any non-empty set of custom transform kernels. The transform set may include one or more kernels.

In some systems, LFNST/NSPT is performed on both intra- and inter-coded blocks based on a gradient direction (e.g., a virtual intra prediction mode) derived from a current prediction's histogram of gradients (HoG) and uses this direction as the classifier to select the transform kernel.

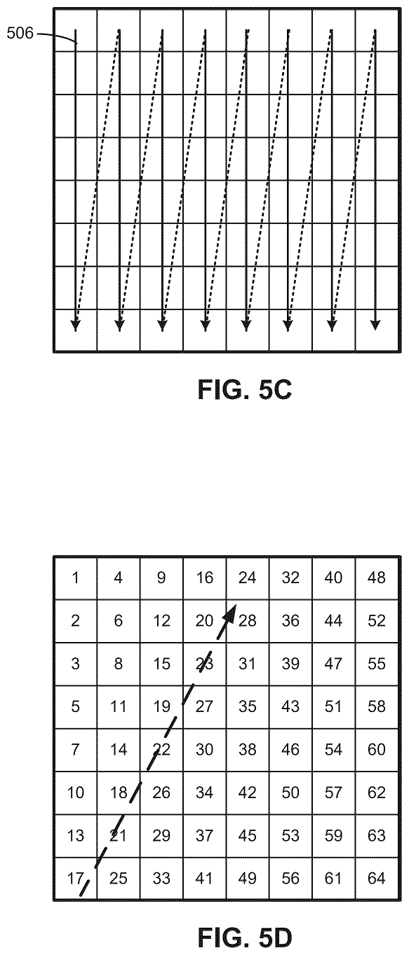

In some embodiments, a classifier is used to determine the kernel set for a current block (e.g., an LFNST/NSPT kernel set). In some embodiments, the classifier employs a decision tree to determine the kernel set. FIGS. 6A and 6B illustrate example decision trees for a classifier in accordance with some embodiments. FIG. 6A illustrates an example decision tree for a combination of affine and motion vector (MV) modes. FIG. 6B illustrates an example decision tree for merge and subblock modes.

In some embodiments, more than one classifier is used to determine the non-primary kernel set. The classifiers may be based on any information that is available to current block to derive the kernel set.

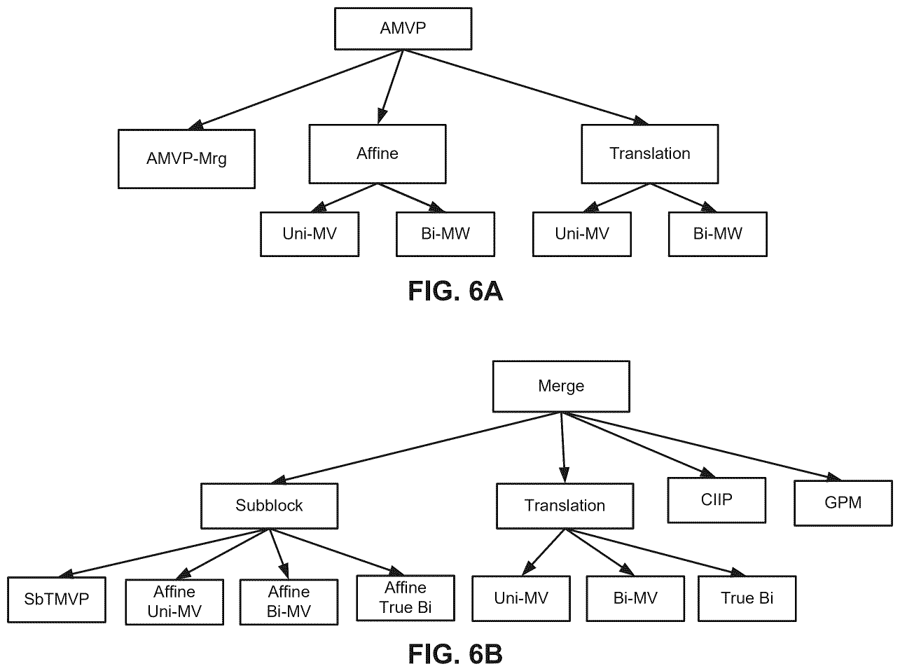

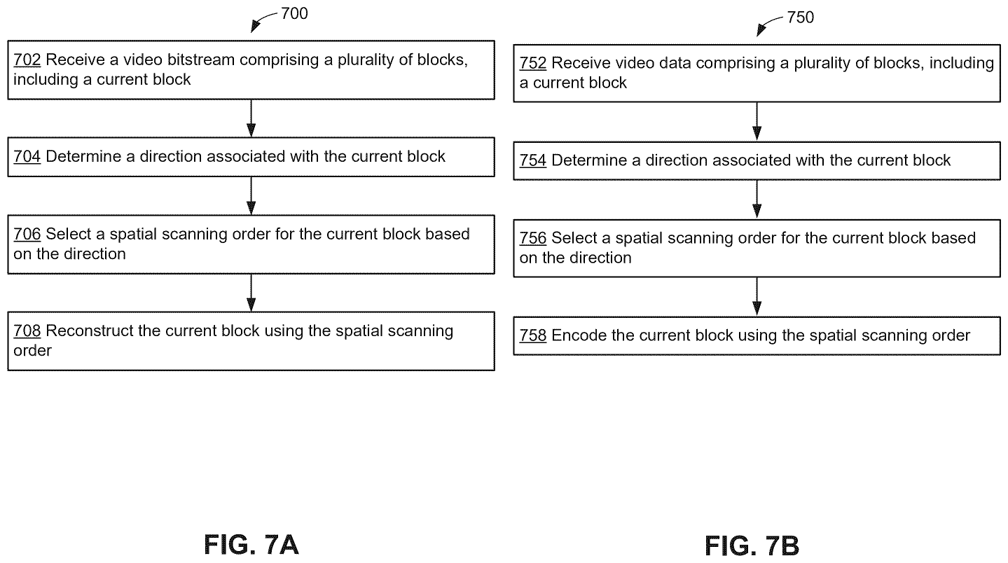

FIG. 7A is a flow diagram illustrating a method 700 of decoding video in accordance with some embodiments. The method 700 may be performed at a computing system (e.g., the server system 112, the source device 102, or the electronic device 120) having control circuitry and memory storing instructions for execution by the control circuitry. In some embodiments, the method 700 is performed by executing instructions stored in the memory (e.g., the memory 314) of the computing system.

The system receives (702) a video bitstream (e.g., a coded video sequence) comprising a plurality of blocks (e.g., encoded blocks), including a current block. The system determines (704) a direction associated with the current block. The system selects (706) a spatial scanning order for the current block based on the direction. The system reconstructs (708) the current block using the spatial scanning order. In this way, a block has a direction which is used to determine the scanning order.

In some embodiments, an intra mode of current block is used to determine the spatial scanning order of the residual block (e.g., as discussed above with respect to FIGS. 5A-5D).

In some embodiments, the scanning order is determined based on a HoG with the largest magnitude for the corresponding prediction block.

In some embodiments, the adaptive scanning only applies on certain blocks based on coding mode information. As an example, all angular modes may share several transform sets and the non-angular modes may have their own transform sets.

In some embodiments, the spatial scanning order of a block may be determined by a characteristic of the prediction for current block. As an example, the scanning order may be determined based on the magnitude of the predicted pixel. For example, the spatial scanning may start from the block corner that has the largest magnitude.

In some embodiments, the scanning order of a block is derived from neighboring block information. For example, the scanning order may be determined based on an intra mode derived from DIMD.

In some embodiments, the block is further partitioned into subblocks based on encoded information. In some embodiments, different scanning methods are applied on each subblock to convert it into an 1D array as input to transform. For example, each subblock may be partitioned by the predict block and assigned a direction (sub-direction), and the scanning within the subblock may be based on the sub-direction and the order among different subblocks may be determined based on a main direction of the entire block.

In some embodiments, a transform set is selected for an intra- or inter-coded block based on dominant direction(s) of its predictor or its template area.

In some embodiments, if the block is coded in conventional intra mode with directional intra prediction mode, the difference between this intra prediction mode and the 1st dominant direction of its template is calculated and used as the classifier.

In some embodiments, if the block is intra coded with a decoder side derivation coding mode, the difference between 1st and 2nd dominant directions is calculated and used as the classifier.

In some embodiments, if the block is intra coded with a decoder side derivation coding mode, the classifier is not used when the difference between 1st and 2nd dominant directions is smaller than a predefine threshold value. As an example, in this case, a predefined transform kernel for the intra block is selected without any transform kernel classification.

In some embodiments, if a dominant direction of the block's predictor is used as the classifier, when the difference between the 1st and 2nd dominant directions is smaller than a predefined threshold value, the dominant direction of its template is used. In some embodiments, if the block is intra coded, its coding mode information (e.g., conventional, decoder side, template matching, block vector base, etc.) is used as the classifier.

In some embodiments, if the block is coded in an inter mode, its predictor is used to calculate a set of dominant directions and the difference between 1st and 2nd dominant directions is calculated and used as the classifier.

In some embodiments, if the block is coded in an inter mode, its template is used to calculate a set of dominant directions and the difference between 1st and 2nd dominant directions is calculated and used as the classifier.

In some embodiments, an inter coding tool's enable/disable flag or a combination of these flags for the current block maybe used as classification criteria. For example, whether affine inter prediction is used or not may be used to split the inter blocks into different classifiers. As another example, the number of motion vectors (uni-MV, bi-MV) used by the current block may be used as a classifier. For example, as shown in FIG. 6A, a combination of affine and #MVs may be used together to build a decision tree. As another example, as shown in FIG. 6B, a combination of merge and subblock may be used together to build a decision tree. As another example, the decision tree in FIGS. 6A-6B may be combined together and used as classifier. In another example, flags such as GPM, CIIP, SbTMVP etc. maybe used as classifiers.

In some embodiments, information from the inter coding tools and the virtual intra prediction mode are used as the classification criteria. For example, for the inter blocks with the same/similar VIPM, the inter flags maybe used to further split the blocks into finer groups. Each group may have a separate transform kernel set.

In some embodiments, unsupervised classifiers are trained based on the information available to re-classifier the inter blocks. In some embodiments, the transform kernel for inter blocks is retrained after using the inter classification method.

In some embodiments, the classifiers are enabled and apply on all inter blocks. In some embodiments, a flag is signaled to indicate the usage of the classifiers (e.g., signaled at a CU, slice, and/or picture level). In some embodiments, the usage of the classifiers is derived from the information available.

In some embodiments, for intra coding block with enabled non-primary transform flag, intra prediction mode and/or the coding information of the intra coding block is used to derive the transform kernel set. A non-conventional intra prediction mode may be any non-planar, DC or angular intra prediction mode such as EIP, PDP/MIP, SGPM, IntraTMP, DIMD, TIMD, . . . , etc. In this case, those non-conventional intra prediction modes may have their own non-primary transform kernel set(s) that are different from the kernel set used for conventional intra modes. As an example, those non-conventional intra prediction modes may share a same non-primary kernel set. This non-primary kernel set may be a separate transform kernel set designed for non-conventional intra prediction modes. In another example, at least one of the non-conventional intra prediction modes shares the same transform kernel set with the existing conventional transform kernel set. In another example, the classifier for the non-conventional intra prediction modes may be derived based on their prediction signal.

In some embodiments, in addition to the prediction modes, additional intra prediction information is used to decide the transform kernel set to be used. For example, the partition modes/angle from SGPM may be used. Different partition/angles may have different transform kernel sets. As another example, the template matching cost for IntraTMP may be used by splitting the cost into several groups and assign different transform kernel set to different groups. In another example, block characteristic like HoG of prediction blocks, may be used to decide the transform set.

In some embodiments, a CU-, tile-, slice-, and/or picture-level flag is signaled to indicate the usage of the classifiers. In some embodiments, the usage of the classifiers is enabled without signaling. For example, the usage of the non-primary may be derived from the information available. As another example, the classifiers may be enabled and apply on all candidate blocks.

In some embodiments, for inter blocks with enabled non-primary transform flag, the coding information of current coding block or its reference blocks is used to decide the transform kernel set to be used. For example, the inter prediction modes such as affine, bi-prediction, true-bi-prediction, uni-prediction, GPM, etc, are used to determine the transform kernel sets.

In some embodiments, the inter prediction information is used to determine the transform kernel set. For example, the partition and/or angle information from GPM may be used. As another example, the partition and/or direction information from SBT may be used. As another example, block characteristics, such as HoG of prediction blocks, may be used to decide the transform set.

In some embodiments, the information from the reference blocks is used to determine the transform kernel set. For example, the transform kernel set used for reference area may be inherited. As another example, when multiple reference blocks available, the fusion weights may be used to determine the transform kernel sets.

In some embodiments, a flag is signaled (e.g., at a block level or in high-level syntax) to indicate the usage of the classifiers. In some embodiments, the usage of the classifiers is enabled without signaling. For example, the usage of the non-primary may be derived from the information available. As another example, the classifiers may be enabled and apply on all candidate blocks.

In some embodiments, the non-primary techniques described above are performed for primary transform kernels other than DCT2. For example, the non-primary may be performed after MTS. As another example, different horizontal and vertical transform type combination may have different non-primary transform sets.

In some embodiments, the non-primary for other primary transform kernels is controlled by a flag (e.g., at a block level or in high-level syntax). With N_i (N_i>=1) transform kernels in kernel set i.

In some embodiments, the non-primary for other primary transform kernels is enabled without signaling. For example, the non-primary may be applied for all qualified blocks. As another example, the non-primary may be performed by inferring the flag from available information such as sum of residual, HoG, etc. In some embodiments, transform flags, such as SBT, have their own non-primary kernels.

In some embodiments, block size is used as the classifier for the non-primary transform, e.g., different block size may have different non-primary transform kernel (and/or transform set). As an example, 4×16 and/or 16×4 may has its own transform kernel sets.

In some embodiments, for certain blocks size, the transform kernel sets have different shapes. For example, 4×16 blocks may select the transform kernel sets from non-primary transform kernel sets for block size 4×4, 4×8 or 4×16 by having different zero-out ranges during the primary transform.

In some embodiments, the selection of transform kernel sets from different transform kernel sizes may be signaled by a flag (e.g., via a block-level or high-level syntax).

In some embodiments, the selection of transform kernel sets from different transform kernel size is derived without signaling. For example, for an SBT block (e.g., area to be encoded is 4×16 block), it will use the 4×4 non-primary transform kernel sets.

FIG. 7B is a flow diagram illustrating a method 750 of encoding video in accordance with some embodiments. The method 750 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 750 is performed by a same system as the method 700 described above.

The system receives (752) video data (e.g., a source video sequence) comprising a plurality of blocks (e.g., corresponding to one or more frames), including a current block. The system determines (754) a direction associated with the current block. The system selects (756) a spatial scanning order for the current block based on the direction. The system encodes (758) the current block using the spatial scanning order. In some embodiments, the system transmits the encoded current block via a video bitstream. As described previously, the encoding process may mirror the decoding processes described herein (e.g., transforms and scanning orders). For brevity, those details are not repeated here.

Notably, the transforms performed during decoding of the video bitstream may be inverses of the transformed performed during encoding of the video bitstream, and are sometimes referred to as “inverse transforms.” Thus, while the encoder component applies transforms, the decoder component performs the inverse transforms. Transforms described herein in the context of the decoder component may be the inverse of the transforms applied on the encoder side. For simplicity, the transformations described herein may be referred to as “transforms” whether performed during encoding or decoding.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.
(A1) In one aspect, some embodiments include a method (e.g., the method 700) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) determining a direction associated with the current block; (iii) selecting a spatial scanning order for the current block based on the direction; and (iv) reconstructing the current block using the spatial scanning order. In this way, each block may have a direction which helps to determine the scanning order. For example, the spatial scanning order is used for a residual block for the current block. In some embodiments, the spatial scanning order is selected from a set of predefined scanning orders.
(A2) In some embodiments of A1, the direction associated with the current block is determined based on prediction information for the current block. For example, intra mode of current block may be used to determine the spatial scanning order of the residual block.
(A3) In some embodiments of A2, the prediction information comprises a magnitude of a predicted pixel. For example, the spatial scanning order of a block may be determined by the characteristic of the prediction for current block. As an example, the scanning order may be decided by the magnitude of the predicted pixel. An example scanning order proceeds from a largest predicted pixel value to a smallest predicted pixel value.
(A4) In some embodiments of A3, the current block comprises a plurality of predicted pixels, and wherein the scanning order is selected to start at a location corresponding to a largest magnitude for the plurality of predicted pixels. For example, the spatial scanning may always start from the block corner which has the largest magnitude.
(A5) In some embodiments of any of A1-A4, the direction associated with the current block is determined based on a histogram of gradients (HoG) for the current block. For example, the scanning order may be decided by the HoG with largest magnitude of the prediction block.
(A6) In some embodiments of any of A1-A5, the spatial scanning order is selected in accordance with a determination that adaptive spatial scanning is to be used for the current block. For example, the adaptive scanning may only apply on certain blocks based on coding mode information.
(A7) In some embodiments of A6, the determination that the spatial scanning order is to be selected for the current block is based on whether an intra prediction mode for the current block is an angular prediction or a non-angular prediction. For example, all the angular modes may share several transform sets and the nonangular modes may have their own transform sets.
(A8) In some embodiments of any of A1-A7, the direction associated with the current block is determined based on neighboring block information for the current block. For example, the scanning order of a block may be derived from neighbor information.
(A9) In some embodiments of A8, the scanning order is selected according to an intra mode derived from a decoder-side intra mode derivation. For example, the scanning order may be decided based on the intra mode derived from DIMD.
(A10) In some embodiments of any of A1-A9, selecting the spatial scanning order for the current block comprises selecting respective scanning orders for each of a plurality of sub-blocks of the current block. For example, the block can be further partitioned into subblocks based on encoded information and apply different scanning methods on each subblock to convert it into an 1D array as input to transform. As an example, each subblock can be partitioned by the predict block and assign a direction (sub-direction) to them, and the scanning within the subblock may be decided by sub-direction and the order among different subblocks may be decided by the main direction of the entire block. In some embodiments, the current block is partitioned into a plurality of subblocks. In some embodiments, prediction information is determined for each subblock of the plurality of subblocks. In some embodiments, a direction is determined for each subblock based on the respective prediction information. In some embodiments, a scanning order is determined for each subblock based on the respective direction.
(A11) In some embodiments of any of A1-A10, the method further comprises selecting a transform set for the current block based on the direction, wherein the current block is reconstructed using the selected transform set. For example, the transform set is selected for intra or inter coded block based on the dominant directions of its predictor or its template area.
(A12) In some embodiments of A11, when the current block is encoded with a directional intra prediction mode, the direction associated with the current block is determined based on a difference between the directional intra prediction mode and a dominant direction of a template corresponding to the current block. For example, if the block is coded in conventional intra mode with directional intra prediction mode, the difference between this intra prediction mode and the 1st dominant direction of its template is calculated and being used as the classifier. As an example, the accuracy of each classifier may be estimated based on the difference between the first and second dominate directions.
(A13) In some embodiments of A11 or A12, when the current block is encoded with a decoder-side intra mode derivation (DIMD), the direction associated with the current block is determined based on a difference between a first dominant direction of a template corresponding to the current block and a second dominant direction of the template. For example, if the block is coded in conventional intra mode with directional intra prediction mode, the difference between this intra prediction mode and the 1st dominant direction of its template is calculated and being used as the classifier.
(A14) In some embodiments of A13, a predefined transform kernel is used for the current block when the difference between the first dominant direction and the second dominant direction is less than a threshold. For example, if the block is intra coded with decoder side derivation coding mode, the classifier cannot be used when the difference between 1st and 2nd dominant directions is smaller than a predefine threshold value. In this case, a predefine transform kernel for the intra block is selected without any transform kernel classification. In some embodiments, if dominant directions of its predictor is used as classifier, when the difference between the 1st and 2nd dominant directions is smaller than a predefine threshold value, the dominant directions of its template is used. In another embodiment if the block is intra coded its coding mode (conventional or decoder side or template matching or block vector base etc.) is used as the classifier.
(A15) In some embodiments of any of A11-A14, when the current block is encoded with an inter prediction mode, the direction associated with the current block is determined based on a predictor of the inter prediction mode. For example, if the block is coded in inter mode, its predictor is used to calculate a set of dominant directions and the difference between 1st and 2nd dominant directions is calculated and being used as the classifier.
(A16) In some embodiments of any of A11-A15, when the current block is encoded using a template, the direction associated with the current block is determined based on the template. For example, if the block is coded in inter mode, its template is used to calculate a set of dominant directions and the difference between 1st and 2nd dominant directions is calculated and being used as the classifier.
(A17) In some embodiments of any of A1-A16, selecting the spatial scanning order based on the direction comprises using a classifier to determine the scanning order based on the direction.
(A18) In some embodiments of any of A1-A17, the method further comprises using a classifier and coding information to determine a non-primary kernel set for the current block. For example, for an intra coded block with an enabled non-primary transform flag, intra prediction mode and/or other coding information of the intra coding block can be used to derive the transform kernel set.
(B1) In another aspect, some embodiments include a method (e.g., the method 750) of video encoding. In some embodiments, the method is performed at a computing system having memory and one or more processors. The method includes: (i) receiving video data (e.g., a source video sequence) comprising a plurality of blocks, including a current block; (ii) determining a direction associated with the current block; (iii) selecting a spatial scanning order for the current block based on the direction; and (iv) encoding the current block using the spatial scanning order
(B2) In some embodiments of B1, the method further includes encoding-side analogues of any of the features described above with respect to A1-A18.
(C1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) determining a direction of the current block; (iii) selecting a transform set for the current block based on the direction; and (iv) reconstructing the current block using the transform set. In this way, the transform set is selected for intra or inter coded block based on the dominant directions of its predictor or its template area.
(C2) In some embodiments of C1, the direction of the current block is determined using any of the techniques or methods described herein.
(C3) In some embodiments of C1 or C2, selecting the transform set based on the direction comprises using a classifier to determine transform set based on the direction.
(D1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) determining a transform kernel for the current block using a classifier; and (iii) reconstructing the current block using the transform kernel. In this way, classifiers for inter blocks may be used to determine the LFNST/NSPT kernel set. The classifiers maybe based on more information that is related to inter blocks' characteristic to achieve better energy compaction for inter blocks.
(D2) In some embodiments of D1, the classifier determines the transform kernel based on inter prediction information of the current block. For example, the inter coding tool's enable/disable flag or the combinations of these flags for the current block maybe used as the classification criteria.
(D3) In some embodiments of D2, the inter prediction information comprises information regarding whether an affine inter prediction is used for the current block. For example, whether affine inter prediction is used or not may be used to split the inter blocks into different classifiers.
(D4) In some embodiments of D2 or D3, the inter prediction information comprises information regarding whether the current block using one or more motion vectors. For example, the number of motion vectors (uni-MV, bi-MV) used by the current block may be used as a classifier.
(D5) In some embodiments of any of D1-D4, the classifier is selected using a decision tree. For example, as FIG. 6A shows, the combination of affine and #MVs may be used together to build a decision tree. As another example, as FIG. 6B shows, the combination of merge and subblock may be used together to build a decision tree. As another example, the decision tree in both FIGS. 6A and 6B may be combined together and used as classifier.
(D6) In some embodiments of any of D1-D5, one or more flags corresponding to the current block are used to select the classifier. For example, flags like GPM, CIIP, SbTMVP etc. maybe used as classifiers.
(D7) In some embodiments of any of D1-D6, determining the transform kernel for the current block using the classifier comprises determining the transform kernel using inter prediction information and virtual intra prediction information for the current block. For example, both information from the inter coding tools and the virtual intra prediction mode may be used as the classification criteria.
(D8) In some embodiments of D7, the current block is classified based on the virtual intra prediction information and one or more inter prediction flags. For the inter blocks with the same/similar VIPM, the inter flags maybe used to further split the blocks into finer groups. Each group may have a separate transform kernel set.
(D9) In some embodiments of any of D1-D8, the classifier is an unsupervised classifier.
(D10) In some embodiments of D9, the unsupervised classifier is trained based on the inter prediction information for the current block. For example, unsupervised classifiers maybe trained based on the information available to classify the inter blocks. As another example, the transform kernel for inter blocks maybe retrained after using the proposed inter classification method.
(D11) In some embodiments of any of D1-D10, the current block is an inter block. An inter block is a block that is predicted using an inter prediction mode. As an example, the classifiers may be enabled and apply on all inter blocks.
(D12) In some embodiments of any of D1-D11, the classifier is used in accordance with a flag in the video bitstream. For example, a CU, slice, or picture level flag may be signaled to indicate the usage of the proposed classifiers.
(D13) In some embodiments of any of D1-D11, the method further comprises determining to use the classifier based on coded information. For example, the usage of the classifiers may be derived from the information available.
(E1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) determining a transform kernel set for the current block using a classifier selected from a set of two or more classifiers; and (iii) reconstructing the current block using a transform kernel from the transform kernel set. In this way, more than one classifier may be used to determine the non-primary kernel set. The classifiers maybe based on any information that is available to current block to derive the kernel set.
(E2) In some embodiments of E1, the current block is an intra block, and wherein the transform kernel set is determined using intra prediction information of the current block. An intra block is a block that is predicted using an intra prediction mode. As an example, for intra coding block with enabled non-primary transform flag, intra prediction mode and/or the coding information of the intra coding block can be used to derive the transform kernel set. In some embodiments, in addition to the prediction modes, more intra prediction information may be used to decide the transform kernel set to be used.
(E3) In some embodiments of E2, a first kernel set is used for blocks encoded with a non-conventional intra prediction mode, and a second kernel set is used for blocks encoded with a conventional intra prediction mode. For example, non-conventional intra prediction mode can be any non-planar, DC or angular intra prediction mode such as EIP, PDP/MIP, SGPM, IntraTMP, DIMD, TIMD, . . . , etc. In this case, for those non-conventional intra prediction mode may have their own non-primary transform kernel set that are different from the kernel set used for conventional intra modes.
(E4) In some embodiments of E3, the first kernel set is used when the current block has one of multiple non-conventional intra prediction modes. For example, non-conventional intra prediction modes may share a same non-primary kernel set. This non-primary kernel set is a separate transform kernel set designed for non-conventional intra prediction modes.
(E5) In some embodiments of E3 or E4, the first kernel set is used when the current block has a first non-conventional intra prediction mode or a first conventional intra prediction mode. For example, at least one of those non-conventional intra prediction modes share the same transform kernel set with the existing conventional transform kernel set.
(E6) In some embodiments of any of E1-E5, the classifier is selected based on prediction information for the current block. For example, the classifier for those non-conventional intra prediction modes is derived based on their prediction signal.
(E7) In some embodiments of any of E1-E6, the transform kernel set is determined based on partition information for the current block. For example, the partition modes/angle from SGPM may be used. Different partition/angles may have different transform kernel sets.
(E8) In some embodiments of any of E1-E7, the transform kernel set is determined based on template matching information for the current block. For example, the template matching cost for IntraTMP may be used by splitting the cost into several groups and assign different transform kernel set to different groups.
(E9) In some embodiments of any of E1-E8, the transform kernel set is determined based on histogram information for the current block. For example, the blocks characteristic like HoG of prediction blocks, may be used to decide the transform set.
(E10) In some embodiments of any of E1-E9, the method further comprises parsing a flag of the video bitstream to determine whether to use the classifier to determine the transform kernel set. For example, a CU, tile, slice, or picture level flag may be signaled to indicate the usage of the proposed classifiers. In some embodiments, the usage of the classifiers is enabled without signaling. For example, the usage of the non-primary maybe derived from the information available. As another example, the proposed classifiers may be enabled and apply on all possible candidate blocks.
(E11) In some embodiments of any of E1-E10, the transform kernel set is determined based on neighboring information for the current block. For example, for inter blocks with enabled non-primary transform flag, from the coding information of current coding block or its reference blocks may be used to decide the transform kernel set to be used. The neighboring information include the inter prediction modes like Affine, Bi-prediction, True-Bi-prediction, Uni-prediction, GPM, etc, may be used to decide the transform kernel sets. As an example, the information from the reference blocks may be used to determine the transform kernel set. For example, the transform kernel set used for reference area can be inherited. As another example, when multiple reference blocks available, the fusion weights may be used to determine the transform kernel sets.
(E12) In some embodiments of any of E1-E11, the transform kernel set is determined based on prediction information for the current block. For example, inter prediction information can be used to determine the transform kernel set.
(E13) In some embodiments of any of E1-E12, the transform kernel set is determined for the current block using the classifier when a primary transform of the current block is not DCT2. For example, the transform kernel set is a non-primary transform kernel set, and the non-primary may be performed for primary transform kernels other than DCT2. As an example, non-primary may be performed after MTS. For example, the different horizontal and vertical transform type combination may have different non-primary transform sets.
(E14) In some embodiments of any of E1-E13, the transform kernel set is determined based on a block size of the current block. For example, block size can be the classifier for the non-primary transform, different block size may have different non-primary transform kernel (set).

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 700, 750, as well as A1-A18, B1-B2, C1-C3, D1-D13, and E1-E14 above).

In another aspect, some embodiments include a non-transitory computer-readable storage medium storing one or more sets of instructions for execution by control circuitry of a computing system, the set(s) of instructions including instructions for performing any of the methods described herein (e.g., the methods 700, 750, as well as A1-A18, B1-B2, C1-C3, D1-D13, and E1-E14 above). In some embodiments, a memory or non-transitory computer-readable storage medium stores a video bitstream including any of the features (e.g., syntax and encoded information) disclosed herein.

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
determining a direction associated with the current block;
selecting a spatial scanning order for the current block based on the direction; and
reconstructing the current block using the spatial scanning order.

2. The method of claim 1, wherein the direction associated with the current block is determined based on prediction information for the current block.

3. The method of claim 2, wherein the prediction information comprises a magnitude of a predicted pixel.

4. The method of claim 3, wherein the current block comprises a plurality of predicted pixels, and wherein the scanning order is selected to start at a location corresponding to a largest magnitude for the plurality of predicted pixels.

5. The method of claim 1, wherein the direction associated with the current block is determined based on a histogram of gradients (HoG) for the current block.

6. The method of claim 1, wherein the spatial scanning order is selected in accordance with a determination that the spatial scanning order is to be selected for the current block.

7. The method of claim 6, wherein the determination that the spatial scanning order is to be selected for the current block is based on whether an intra prediction mode for the current block is an angular prediction or a non-angular prediction.

8. The method of claim 1, wherein the direction associated with the current block is determined based on neighboring block information for the current block.

9. The method of claim 8, wherein the scanning order is selected according to an intra mode derived from a decoder-side intra mode derivation.

10. The method of claim 1, wherein selecting the spatial scanning order for the current block comprises selecting respective scanning orders for each of a plurality of sub-blocks of the current block.

11. The method of claim 1, further comprising selecting a transform set for the current block based on the direction, wherein the current block is reconstructed using the selected transform set.

12. The method of claim 11, wherein:
when the current block is encoded with a directional intra prediction mode, the direction associated with the current block is determined based on a difference between the directional intra prediction mode and a dominant direction of a template corresponding to the current block.

13. The method of claim 11, wherein:
when the current block is encoded with a decoder-side intra mode derivation (DIMD), the direction associated with the current block is determined based on a difference between a first dominant direction of a template corresponding to the current block and a second dominant direction of the template.

14. The method of claim 13, wherein a predefined transform kernel is used for the current block when the difference between the first dominant direction and the second dominant direction is less than a threshold.

15. The method of claim 11, wherein:
when the current block is encoded with an inter prediction mode, the direction associated with the current block is determined based on a predictor of the inter prediction mode.

16. The method of claim 11, wherein:
when the current block is encoded using a template, the direction associated with the current block is determined based on the template.

17. The method of claim 1, wherein selecting the spatial scanning order based on the direction comprises using a classifier to determine the scanning order based on the direction.

18. The method of claim 1, further comprising using a classifier and coding information to determine a non-primary kernel set for the current block.

19. A method of video encoding performed at a computing system having memory and one or more processors, the method comprising:
receiving video data comprising a plurality of blocks, including a current block;
determining a direction associated with the current block;
selecting a spatial scanning order for the current block based on the direction; and
encoding the current block using the spatial scanning order.

20. A non-transitory computer-readable storage medium storing a video bitstream that is generated by a video encoding method, the video encoding method comprising:
determining a direction associated with a current block of video data;
selecting a spatial scanning order for the current block based on the direction; and
encoding the current block using the spatial scanning order; and
wherein the video bitstream comprises the encoded current block.
